(19) United States
(12) Patent Application Publication
(10) Pub. No.: US 2012/0180656 A1
(43) Pub. Date: Jul. 19, 2012

(54) APPARATUS AND METHOD FOR POWER-FREE FILTRATION USING OSMOTIC PRESSURE

(75) Inventors: Seong Pil JEONG, Seoul (KR); Seock Heon LEE, Seoul (KR); Young Beom YU, Seoul (KR)

(73) Assignee: KOREA INSTITUTE OF SCIENCE AND TECHNOLOGY, Seoul (KR)

(21) Appl. No.: 13/331,672

(22) Filed: Dec. 20, 2011

(30) Foreign Application Priority Data
Jan. 19, 2011 (KR) 10-2011-0005540

(51) Int. Cl. B01D 61/06; B01D 53/22; B01D 61/08; B01D 36/00; B01D 61/02

(52) U.S. Cl. 95/45; 210/314; 210/652; 96/4

(57) ABSTRACT

Provided is an apparatus and method for filtration using osmosis, which induce osmotic pressure and allow separation of pure fluid by using the reduced osmotic pressure as an energy source, and thus carry out filtration without any additional energy supply.

### CROSS-REFERENCE TO RELATED APPLICATION

This application claims priority to Korean Patent Application No. 10-2011-0005540, filed on Jan. 19, 2011, and all the benefits accruing therefrom under 35 U.S.C. §119, the contents of which in its entirety are herein incorporated by reference.

### BACKGROUND

1. Field

The present disclosure relates to an apparatus and a method for power-free filtration using osmotic pressure.

2. Description of the Related Art

In general, as methods for separating pure fluid from fluid containing impurities. evaporation, adsorption, filtration, electrolysis and gravimetric separation methods have been used. Among such methods, filtration methods using reverse osmosis membranes have been used most frequently. In addition, evaporation methods have been used frequently because it has high removal efficiency. Recently, active studies have been conducted about filtration methods using forward osmosis membranes, filtration methods using aqua-porin or carbon nanotubes and membrane distillation processes.

However, such methods for separation of pure fluid according to the related art require continuous energy consumption. In order to reduce energy consumption, improvement in the known processes, development of membranes, and introduction of chemicals have been suggested. However, such solutions are still not energy-efficient.

### SUMMARY

The present disclosure is directed to an apparatus and method for power-free filtration using osmosis, which may induce osmotic pressure and allow separation of pure fluid by using the osmotic pressure as an energy source, and thus carry out filtration without any other energy supply.

In an exemplary embodiment, an apparatus for power-free filtration using osmotic pressure may include an osmosis system and a filtration system. The osmosis system may include an impurity-containing fluid feed unit and an osmosis-inducing fluid storage unit with an osmosis medium interposed therebetween. The filtration system may include an osmosis-inducing fluid storage unit and a pure fluid storage unit with a filtration medium interposed therebetween. Due to the generation of osmotic pressure in the osmosis system, pure fluid in the impurity-containing fluid is introduced to the osmosis-inducing fluid storage unit, while the osmotic pressure is applied to the osmosis-inducing fluid storage unit. In addition, the osmotic pressure applied to the osmosis-inducing fluid storage unit acts on the fluid in the osmosis-inducing fluid storage unit, thereby performing filtration through the filtration medium.

In an exemplary embodiment, the osmosis-inducing fluid has a higher impurity concentration than the impurity concentration of the impurity-containing fluid.

In an exemplary embodiment, the osmosis medium may be a medium that induces osmosis, and the filtration medium may have higher permeability than that of the osmosis medium. In an exemplary embodiment, the osmosis medium has a plurality of pores and each pore is smaller in size than the impurity contained in the impurity-containing fluid

In another exemplary embodiment, a method for power-free filtration using osmotic pressure may include: generating osmotic pressure between an impurity-containing fluid and an osmosis-inducing fluid through an osmosis medium; allowing a pure fluid in the impurity-containing fluid to be introduced to the osmosis-inducing fluid due to generation of osmotic pressure, while applying the osmotic pressure to the osmosis-inducing fluid; and carrying out filtration through a filtration medium under the osmotic pressure applied to the osmosis-inducing fluid.

In another exemplary embodiment, a method for power-free filtration using osmotic pressure may use an apparatus for power-free filtration including: an osmosis-inducing fluid storage unit having a certain volume and provided with osmosis-inducing fluid therein; an osmosis medium and a filtration medium each provided at one end of the osmosis-inducing fluid storage unit; and an impurity-containing fluid feed unit provided at one side of the osmosis medium. The method for power-free filtration may include: generating osmotic pressure between the impurity-containing fluid and the osmosis-inducing fluid through the osmosis medium; allowing pure fluid in the impurity-containing fluid to be introduced to the osmosis-inducing fluid storage unit due to the generation of osmotic pressure, while applying the osmotic pressure to the osmosis-inducing fluid storage unit; and carrying out filtration through the filtration medium under the osmotic pressure applied to the fluid in the osmosis-inducing fluid storage unit.

According to the embodiments of the present disclosure, osmotic pressure induced in the filtration apparatus is used as the energy source in the filtration apparatus, which allows no need of the input of power. In particular, according to an exemplary embodiment, the osmotic pressure generated by the osmosis system is applied to the filtration system, while the osmosis system and the filtration system are disposed sequentially. As a result, it is possible to carry out filtration with no input of power.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view illustrating a power-free apparatus for filtration using osmosis according to an exemplary embodiment.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

In the context, power-free means no input of power is required and only the osmotic pressure induced in the filtration apparatus may be used as the energy source in the filtration apparatus. In the context, impurity-containing fluid means a fluid containing a material to be separated (i.e., impurity) therein. Examples of the impurity-containing fluid include, but is not limited to, a liquid containing contaminants or gas containing harmful molecules.

In the apparatus and the method according to embodiments of the present disclosure, osmotic pressure is induced through the osmosis system of the filtration apparatus and the induced osmotic pressure is used as an energy source for separation of pure fluid in the filtration apparatus. Therefore, any input of power for driving filtration is not required. Such an apparatus for filtration may be applied to processes for separation of any impurity included in any impurity-containing fluid (for example, atmosphere, seawater, contaminated liquid such as sewage and waste or harmful molecules-containing gas).

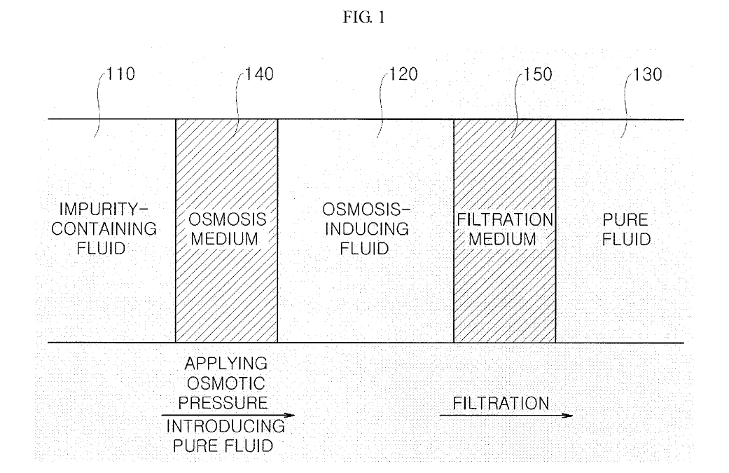

FIG. 1 is a schematic view illustrating an apparatus for filtration using osmosis according to an exemplary embodiment.

Referring to FIG. 1, the apparatus for power-free filtration using osmosis according to an exemplary embodiment includes an impurity-containing fluid feed unit 110, an osmosis medium 140, an osmosis-inducing fluid storage unit 120, a filtration medium 150 and a pure fluid discharge unit 130.

The impurity-containing fluid feed unit 110, the osmosis medium 140 and the osmosis-inducing fluid storage unit 120 may form an osmosis system. In addition, the osmosis-inducing fluid storage unit 120, the filtration medium 150 and the pure fluid discharge unit 130 may form a filtration system.

According to another exemplary embodiment, impurity-containing fluid itself may be in direct contact with the osmosis medium without the impurity-containing fluid feed unit. In addition, the pure fluid discharge unit may be optional.

The osmosis medium 140 is provided between the impurity-containing fluid feed unit 110 and the osmosis-inducing fluid storage unit 120 so that osmotic pressure is induced between the impurity-containing fluid and the osmosis-inducing fluid. To induce osmosis through the osmosis medium 140, it is required that the concentration D_{P} of the osmosis-inducing fluid is higher than the concentration D_{I} of the impurity-containing fluid (D_{P}>D_{I}). Since the concentration D_{P} of the osmosis-inducing fluid is higher than the concentration D_{I} of the impurity-containing fluid, osmotic pressure is applied to the osmosis-inducing fluid.

Meanwhile, the osmosis medium 140 serves not only to induce osmosis but also to filter the impurities contained in the impurity-containing fluid. As a result, the impurities contained in the impurity-containing fluid are filtered by the osmosis medium 140, and pure fluid in the impurity-containing fluid is transferred to the osmosis-inducing fluid storage unit 120 by osmosis.

Explaining the filtration apparatus by referring FIG. 1, when osmotic pressure is generated by the osmosis system (the impurity-containing fluid feed unit 110, the osmosis medium 140 and the osmosis-inducing fluid storage unit 120), and the pure fluid in the impurity-containing fluid is introduced to the osmosis-inducing fluid storage unit 120, the filtration system (the osmosis-inducing fluid storage unit 120, the filtration medium 150 and the pure fluid discharge unit 130) carries out filtration. The osmosis-inducing fluid storage unit 120 is provided with a space having a constant volume.

When the pure fluid is introduced to the osmosis-inducing fluid storage unit 120 while the osmotic pressure is applied thereto, the osmotic pressure is applied to the fluid in the osmosis-inducing fluid storage unit 120 since the osmosis-inducing fluid storage unit 120 has a constant volume. Then, the osmotic pressure applied to the osmosis-inducing fluid storage unit 120 is applied to the filtration medium 150. Since the filtration medium 150 is subject to the osmotic pressure, it is possible to carry out filtration using the filtration medium, and thus to filter the pure fluid. Herein, it is important that the osmosis-inducing fluid storage unit 120 has a constant volume in that the osmotic pressure to change the volume serves as a driving force to the filtration.

When the pure fluid is introduced to the osmosis-inducing fluid storage unit 120, the osmosis-inducing fluid may have a temporarily decreased impurity concentration. However, the osmosis-inducing storage unit 120 has a constant volume and the fluid is discharged immediately to the pure fluid discharge unit 130 by the osmotic pressure applied to the osmosis-inducing fluid storage unit. In addition, only the pure fluid is discharged by the action of the filtration medium 150. As a result, the impurity concentration of the osmosis-inducing fluid may be maintained constantly.

As described above, the apparatus for power-free filtration using osmosis disclosed herein may be applied to both liquid filtration and gas filtration. When applying the apparatus to liquid, the osmosis-inducing fluid may be liquid having a higher impurity concentration as compared to the contaminated liquid. For example, the osmosis-inducing fluid may be aqueous NaCl solution.

In addition, an osmosis membrane may be used as the osmosis medium 140, and the filtration medium 150 may include a filtration membrane having higher permeability as compared to the osmosis medium 140.

Meanwhile, in the case of application to gas, the apparatus for power-free filtration using osmosis disclosed herein may be used for the purpose of filtration of specific molecules in contaminated gas. For example, the apparatus may be used for the purpose of filtration of harmful gas, such as SF₆. For this, it is required for the osmosis medium 140 to have property of filtering specific molecules in addition to ability of inducing osmosis. In this case, it is required for the osmosis medium 140 to have a plurality of pores, wherein each pore is smaller in size than specific molecules (e.g. SF₆). Further, as the osmosis-inducing fluid, gases having a higher impurity concentration as compared to the contaminated gas may be used.

In an exemplary embodiment, a method for power-free filtration may include generating osmotic pressure between an impurity-containing fluid and an osmosis-inducing fluid through an osmosis medium; allowing a pure fluid in the impurity-containing fluid to be introduced to the osmosis-inducing fluid due to generation of osmotic pressure, while applying the osmotic pressure to the osmosis-inducing fluid; and carrying out filtration through a filtration medium under the osmotic pressure applied to the osmosis-inducing fluid.

Further, in another exemplary embodiment, a method for power-free filtration may use the apparatus as explained above which includes an osmosis-inducing fluid storage unit having a certain volume and provided with osmosis-inducing fluid therein, an osmosis medium and a filtration medium each provided at one end of the osmosis-inducing fluid storage unit, and an impurity-containing fluid feed unit provided at one side of the osmosis medium. The method for power-free filtration may include generating osmotic pressure between the impurity-containing fluid and the osmosis-inducing fluid through the osmosis medium, allowing pure fluid in the impurity-containing fluid to be introduced to the osmosis-inducing fluid storage unit due to the generation of osmotic pressure, while applying the osmotic pressure to the osmosis-inducing fluid storage unit, and carrying out filtration through the filtration medium under the osmotic pressure applied to the fluid in the osmosis-inducing fluid storage unit.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. An apparatus for power-free filtration using osmosis, comprising:
an osmosis-inducing fluid storage unit 120 in which an osmosis-inducing fluid is stored;
an osmosis medium 140 provided at one end of the osmosis-inducing fluid storage unit 120; and
a filtration medium 150 provided at the other end of the osmosis-inducing fluid storage unit 120,
wherein the osmosis medium 140 is in contact with impurity-containing fluid and the osmosis-inducing fluid has a higher impurity concentration as compared to the impurity-containing fluid; osmotic pressure is generated between the osmosis-inducing fluid and the impurity-containing fluid through the osmosis medium 140, and pure fluid in the impurity-containing fluid is introduced to the osmosis-inducing fluid storage unit 120 due to the generation of osmotic pressure, while the osmotic pressure is applied to the osmosis-inducing fluid storage unit 120; and the osmotic pressure applied to the osmosis-inducing fluid storage unit 120 acts on the fluid in the osmosis-inducing fluid storage unit 120, thereby performing filtration through the filtration medium 150.

2. The apparatus according to claim 1, wherein the impurity-containing fluid is liquid containing contaminants or gas containing harmful molecules.

3. The apparatus according to claim 1, wherein the osmosis medium 140 comprises a medium inducing osmotic pressure.

4. The apparatus according to claim 1, wherein the filtration medium 150 has higher permeability as compared to the osmosis medium 140.

5. The apparatus according to claim 2, wherein the impurity-containing fluid is gas containing harmful molecules, the osmosis medium 140 has a plurality of pores, and each pore is smaller in size than the harmful molecules.

6. An apparatus for filtration using osmosis, comprising an osmosis system and a filtration system, wherein the osmosis system comprises an impurity-containing fluid feed unit 110 and an osmosis-inducing fluid storage unit 120 with an osmosis medium 140 interposed therebetween; the filtration system comprises an osmosis-inducing fluid storage unit 120 and a pure fluid discharge unit 130 with a filtration medium 150 interposed therebetween; pure fluid in the impurity-containing fluid is introduced to the osmosis-inducing fluid storage unit 120 due to generation of osmotic pressure in the osmosis system, while the osmotic pressure is applied to the osmosis-inducing fluid storage unit 120; and the osmotic pressure applied to the osmosis-inducing fluid storage unit 120 acts on the fluid in the osmosis-inducing fluid storage unit 120, thereby performing filtration through the filtration medium 150.

7. The apparatus according to claim 6, wherein the osmosis-inducing fluid has a higher impurity concentration as compared to the impurity-containing fluid.

8. The apparatus according to claim 6, wherein the impurity-containing fluid is liquid containing contaminants or gas containing harmful molecules.

9. The apparatus according to claim 6, wherein the osmosis medium 140 comprises a medium inducing osmotic pressure.

10. The apparatus according to claim 6, wherein the filtration medium 150 has higher permeability as compared to the osmosis medium 140.

11. The apparatus according to claim 8, wherein the impurity-containing fluid is gas containing harmful molecules, the osmosis medium 140 has a plurality of pores, and each pore is smaller in size than the harmful molecules.

12. A method for power-free filtration using osmosis comprising:
generating osmotic pressure between an impurity-containing fluid and an osmosis-inducing fluid through an osmosis medium;
allowing a pure fluid in the impurity-containing fluid to be introduced to the osmosis-inducing fluid due to generation of osmotic pressure, while applying the osmotic pressure to the osmosis-inducing fluid; and
carrying out filtration through a filtration medium under the osmotic pressure applied to the osmosis-inducing fluid.

13. The method according to claim 12, wherein the method uses an apparatus for filtration comprising an osmosis-inducing fluid storage unit 120 having a constant volume and provided with osmosis-inducing fluid therein, an osmosis medium 140 and a filtration medium 150 each provided at an end of the osmosis-inducing fluid storage unit 120, and an impurity-containing fluid feed unit 110 provided at one side of the osmosis medium 140, and wherein the method comprises generating osmotic pressure between the impurity-containing fluid and the osmosis-inducing fluid by way of the osmosis medium 140; allowing pure fluid in the impurity-containing fluid to be introduced to the osmosis-inducing fluid storage unit 120 due to the generation of osmotic pressure, while applying the osmotic pressure to the osmosis-inducing fluid storage unit 120; and carrying out filtration through the filtration medium 150 under the osmotic pressure applied to the fluid in the osmosis-inducing fluid storage unit 120.

14. The method according to claim 13, wherein the osmosis-inducing fluid has a higher impurity concentration as compared to the impurity-containing fluid.

15. The method according to claim 13, wherein the impurity-containing fluid is liquid containing contaminants or gas containing harmful molecules.

16. The method according to claim 13, wherein the osmosis medium 140 comprises a medium inducing osmotic pressure.

17. The method according to claim 13, wherein the filtration medium 150 has higher permeability as compared to the osmosis medium 140.

18. The method according to claim 15, wherein the impurity-containing fluid is gas containing harmful molecules, the osmosis medium 140 has a plurality of pores, and each pore is smaller in size than the harmful molecules.
